(19) United States
(12) Patent Application Publication
(10) Pub. No.: US 2025/0201235 A1
(43) Pub. Date: Jun. 19, 2025

(54) System and Method for Speech Language Identification

(71) Applicant: Microsoft Technology Licensing, LLC, Redmond, WA (US)

(72) Inventors: Jiarui Guo, Sammamish, WA (US); Franklin Munoz Garcia, Kirkland, WA (US); Vishal C. Chowdhary, Sammamish, WA (US); Alexander J. Neshyba, Portland, OR (US); Nazifa N. Chowdhury, Seattle, WA (US)

(21) Appl. No.: 18/768,934

(22) Filed: Jul. 10, 2024

Related U.S. Application Data
(60) Provisional application No. 63/610,375, filed on Dec. 14, 2023.

(51) Int. Cl. G10L 15/00

(52) U.S. Cl. CPC G10L 15/005

(57) ABSTRACT

A method, computer program product, and computing system for speech language identification. An input speech signal in a particular language of a plurality of languages is received and processed by a plurality of speech recognition processing paths, each speech recognition processing path being configured to recognize a subset of the plurality languages. Each of the plurality of speech recognition processing paths processes the input speech signal using machine learning to identify a language in the associated subset of languages which is a closest match to the particular language of the input speech signal. The processing of the input speech signal by the plurality of speech recognition processing paths results in a plurality of identified languages. The input speech signal and an indication of each of the plurality of identified languages are processed in a further speech recognition processing path to recognize one of the plurality of identified languages as a closest match to the particular language of the input speech signal.

### RELATED APPLICATION(S)

This application claims the benefit of U.S. Provisional Application No. 63/610,375, filed on 14 Dec. 2023, the entire contents of which are incorporated herein by reference.

### BACKGROUND

While language translation applications are known in the art, they require an initial knowledge of the language being translated and the language to which the translation is desired. In such systems, a user must specify the input (source) language and the target language such that the application can receive the input speech, convert the speech into text in the source language, translate the text into the target language and then convert the text into an audio speech signal of the translated language. However, if the source language is not known and the application is not provided with an identification of the source language, it will not be able to perform the translation, since it will not know from what language it needs to perform the text conversion. Further, applications that are able to identify a language may be limited in the number of languages that they are able to identify and may suffer from latency issues if they are able to process for many different languages. Examples of such applications include open-source applications such as Langid.py and Apache Tika.

### BRIEF DESCRIPTION OF THE DRAWINGS

FIG. 1 is a flow chart of an implementation of a speech language identification process;

FIG. 2 is a diagrammatic view of an implementation of the speech language identification process;

FIG. 3 is a flow chart of an example implementation of the speech language identification process; and

FIG. 4 is a diagrammatic view of a computer system and the secure speech language identification process coupled to a distributed computing network.

Like reference symbols in the various drawings indicate like elements.

### DETAILED DESCRIPTION

As will be discussed in greater detail below, implementations of the present disclosure are directed to a system and method for identifying a language in which a received speech signal is spoken without any prior knowledge of what that language is. The system includes a database storing a list of supported languages against which an input speech signal is compared to identify the language of the speech in the signal. An example language identification application is the Azure Speech Service Language Identification application available from Microsoft Inc. however, any language identification application may be implemented in implementations of the disclosure.

An example language identification system includes a feed-forward deep neural network (DNN) that maps variable-length speech segments to embeddings known as X-vectors. The x-vector framework employs a DNN that maps sequences of speech features to fixed-dimensional embeddings, capturing long-term language characteristics through a temporal pooling layer that aggregates information across time. A long-term language characteristic refers to enduring features and patterns inherent in a language that persist over extended periods, often spanning centuries. These characteristics can encompass a range of linguistic elements such as phonetics, grammar, syntax, and vocabulary, which evolve slowly and exhibit remarkable stability. The temporal pooling layer is used to aggregate across the input frames of a speech segment, so that even the input speech segments that are variable-length can be extracted to a single x-vector. Extracted x-vectors utilize classification technology developed for i-vectors. A preferred system utilizes multilingual bottleneck features, data augmentation, and a discriminative Gaussian classifier. Multilingual bottleneck features are a concept in machine learning, particularly in the domain of natural language processing (NLP), where models are trained to understand and generate text in multiple languages. The term “bottleneck” refers to a layer or representation within the model that serves as a bottleneck for language-specific information, forcing the model to learn a shared, language-agnostic representation. Data augmentation is used to increase the amount and diversity of the x-vector DNN training data. A discriminative Gaussian classifier is a type of statistical model used in pattern recognition and machine learning for classification tasks. Unlike generative classifiers, which model the joint probability distribution of the features and the class labels, a discriminative Gaussian classifier focuses on modeling the decision boundary between classes. The architecture involves multiple layers for frame-level processing, statistics pooling, and segment-level processing. The system is trained using a multiclass cross-entropy objective function and incorporates data augmentation techniques such as speed perturbation, additive noises, and reverberation. The x-vectors are extracted at a specific layer before being classified using the Gaussian classifier. In an implementation of the disclosure, the model is trained to extract x-vectors from the speech input and feed the x-vectors into the Gaussian classifier and extracts a 512-dimensional x-vector after the pooling layer for each speech segment for further classification.

Many languages can be supported by such a system, for example 50 languages or more. In order to support a large number of languages, implementations of the disclosure include a plurality of recognizers, each of which comparing the input speech signal to multiple lists of languages in parallel. Each recognizer identifies the language in its list that most closely matches the language of the input speech signal. The input speech signal is then compared to the identified languages from the recognizers in an output recognizer, which identifies the actual language of the input speech signal. The identified actual language is output to a downstream processor, which, when aware of the actual language of the input speech signal, can perform a number of speech recognition-related functions, such as speech translation and speech-to-text processing.

An input speech signal in a particular language of a plurality of languages is received and processed by a plurality of speech recognition processing paths, each speech recognition processing path being configured to recognize a subset of the plurality languages. A speech recognition processing path is a series of computational steps designed to convert spoken language into text. This process begins with capturing the audio signal using a microphone, which transforms the acoustic waves into a digital format. The next step involves preprocessing this audio data to filter out noise and normalize the signal for consistent analysis. The refined signal is then divided into small time frames, typically milliseconds long, for detailed examination. Within these frames, feature extraction techniques, such as Mel-Frequency Cepstral Coefficients (MFCCs), are applied to distill relevant acoustic features that represent the phonetic content of the speech. These features are then fed into a machine learning model, often a combination of acoustic models and language models. The acoustic model, which is usually trained on a large dataset of speech recordings and their transcriptions, maps the extracted features to phonemes, the basic units of sound in a language. The language model, trained on extensive text corpora, predicts the sequence of words based on these phonemes, ensuring that the output is coherent and contextually appropriate. Advanced systems may use neural networks, such as deep learning architectures like Convolutional Neural Networks (CNNs) and Recurrent Neural Networks (RNNs), to improve accuracy by capturing complex patterns in the data. Finally, the predicted word sequences are post-processed to refine the output, correcting any errors and formatting the text properly. This entire processing path, from capturing the audio to producing text, enables applications like virtual assistants, transcription services, and voice-activated controls, making human-computer interaction more natural and efficient.

Each of the plurality of speech recognition processing paths processes the input speech signal to identify a language in the associated subset of languages which is a closest match to the particular language of the input speech signal. The processing of the input speech signal by the plurality of speech recognition processing paths results in a plurality of identified languages. The input speech signal and an indication of each of the plurality of identified languages are processed in a further speech recognition processing path to recognize one of the plurality of identified languages as a closest match to the particular language of the input speech signal.

In a process known in the language identification art, each recognizer 212a, 212b, . . . 212n performs a spoken language identification the process of identifying the language being spoken from an audio input. Language identification in Automatic Speech Recognition (ASR) refers to the process of determining the language spoken in an audio segment without prior knowledge of the content. Language identification is necessary because ASR models are typically trained on specific languages, and accurately identifying the language of an incoming audio signal allows the system to select the appropriate language-specific model for transcription.

The process of language identification involves analyzing acoustic features and patterns in the speech signal to infer the likely language. This can include characteristics such as phonetic structures, intonation, and other acoustic cues that vary across languages. Machine learning techniques, including neural networks, are commonly employed to learn these patterns and make accurate language predictions.

Language identification has practical applications in various domains, such as voice assistants, translation applications, transcription services, and telecommunications. For example, in a voice-controlled device that supports multiple languages, accurate language identification ensures that the system responds appropriately to user commands and transcribes speech accurately based on the identified language. In telecommunications, language identification can be useful for routing calls to appropriate customer service representatives who speak the caller″s language. Efficient language identification enhances the overall performance and usability of ASR systems, making them adaptable to the diverse linguistic landscape encountered in real-world scenarios.

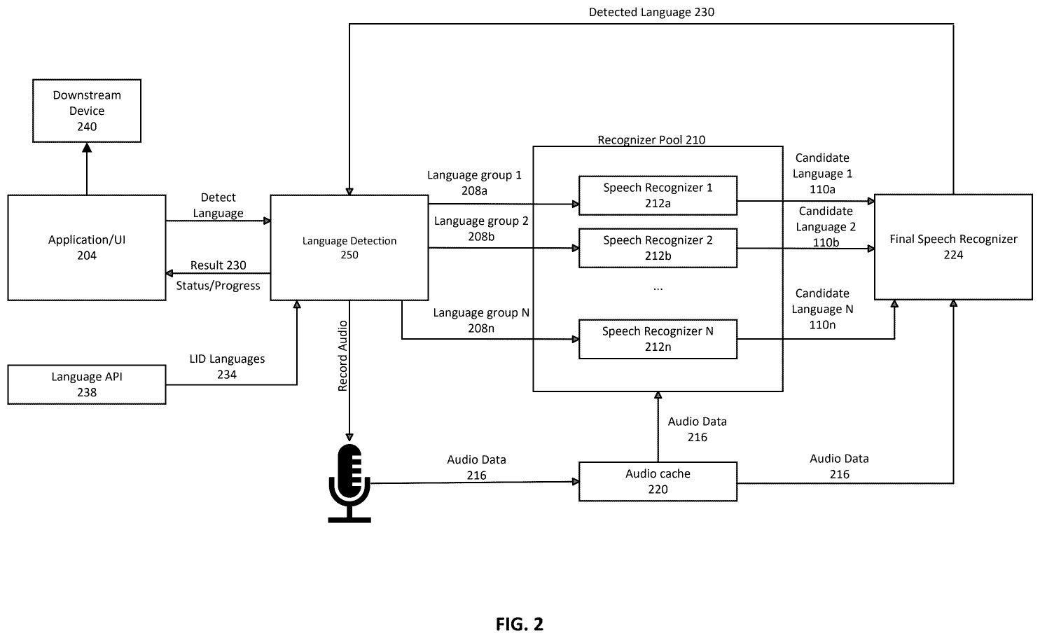

Referring to FIG. 2, an example implementation of the language identification system 200 according to the disclosure will be described. Recognizer pool 210 includes a plurality of speech recognizers 212a, 212b, . . . 212n operating in parallel. Application/UI 204 controls the operation of the system by providing instructions to begin the language detection process and receiving the result 230 of the process for use by downstream device 240 as described below. Language detection controller 250 receives listings of languages 234 from language API 238 and provides instructions to each of speech recognizers 212a, 212b, . . . 212n, respectively to operate to identify the language of input audio data 216 from a set group of languages 208a, 208b, . . . 208n. As described herein, each speech recognizers 212a, 212b, . . . 212n, as a result of the speech recognition process carried out thereby, outputs candidate languages 110a, 110b, . . . 110n to final speech recognizer 224 to perform a speech recognition process on the received candidate languages to determine the detected language 230 for the input audio data signal 216.

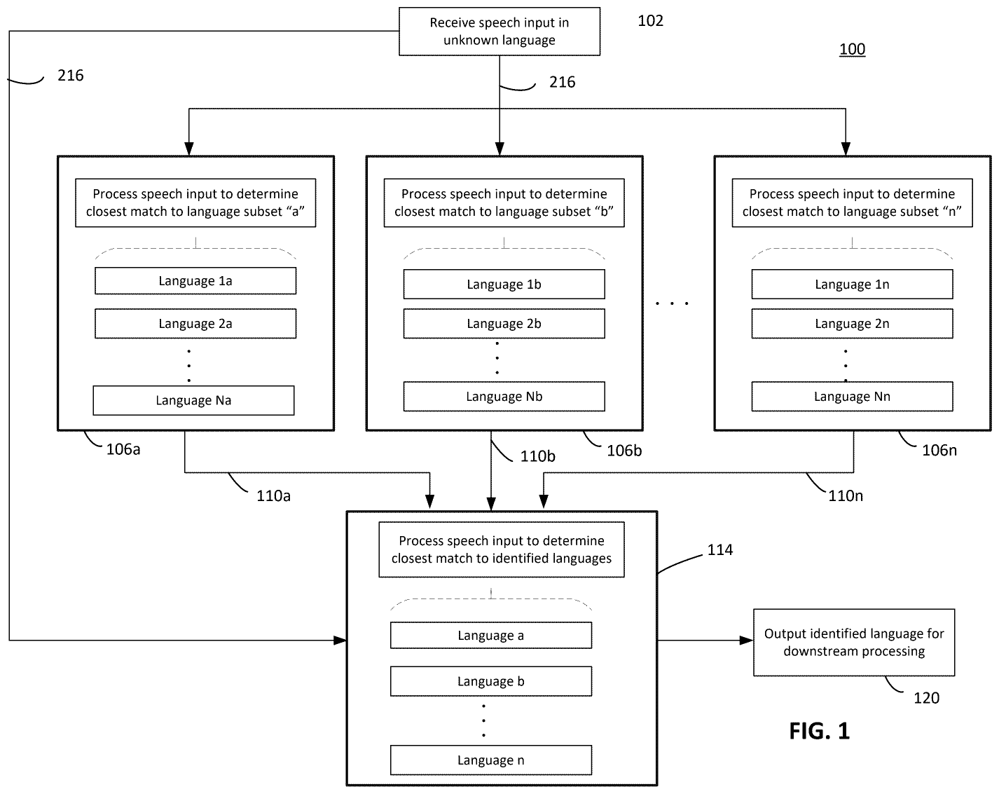

Each recognizer 212a, 212b, . . . 212n is a stand-alone system such as that described above and may utilize one or more of the above language characteristics in identifying the language of the input speech signal 216. Referring to FIG. 1, at 106a, recognizer 212a receives the input speech signal 216 and, using machine learning, performs the speech identification process described above on the number of languages, Language 1a, Language 2a, . . . Language Na in its subset of languages. This processing is done in parallel, such that the input speech signal is compared to each of Language 1a, Language 2a, . . . Language Na concurrently, and a match score is determined for each language. The closer that the language of the input speech signal is to the language to which it is being compared, the higher the score for that language will be. An indication 110a of the language with the highest score is output from recognizer 106a.

Based on the language identification function carried out by recognizer 212a, the language identified as having the highest score and reflected in language indication 110a may or may not be the actual language of the input speech signal. However, it is the language in the subset of languages Language 1a, Language 2a, . . . Language Na that is determined by the recognizer 212a to be the closest match to the language of the input speech signal 216.

At 106b, recognizer 212b receives the input speech signal 216 and, using machine learning, performs a speech identification process on the number of languages, Language 1b, Language 2b, . . . Language Nb in its subset of languages. This processing is done in parallel, such that the input speech signal is compared to each of Language 1b, Language 2b, . . . Language Nb concurrently, and a match score is determined for each language. The closer that the language of the input speech signal is to the language to which it is being compared, the higher the score for that language will be. An indication 110b of the language with the highest score is output from recognizer 106b.

Based on the language identification function carried out by recognizer 212b, the language identified as having the highest score and reflected in language indication 110b may or may not be the actual language of the input speech signal. However, it is the language in the subset of languages Language 1b, Language 2b, . . . Language Nb that is determined by the recognizer 212b to be the closest match to the language of the input speech signal 216.

At 106n, recognizer 212n receives the input speech signal 216 and, using machine learning, performs a speech identification process on the number of languages, Language 1n, Language 2n, . . . Language Nn in its subset of languages. This processing is done in parallel, such that the input speech signal is compared to each of Language 1n, Language 2n, . . . Language Nn concurrently, and a match score is determined for each language. The closer that the language of the input speech signal is to the language to which it is being compared, the higher the score for that language will be. An indication 110n of the language with the highest score is output from recognizer 106n.

Based on the language identification function carried out by recognizer 212n, the language identified as having the highest score and reflected in language indication 110n may or may not be the actual language of the input speech signal. However, it is the language in the subset of languages Language 1n, Language 2n, . . . Language Nn that is determined by the recognizer 212n to be the closest match to the language of the input speech signal 216. It should be understood that, in limited circumstances, the language identified as having the highest score could be a false positive.

Language indications 110a, 110b, . . . 110n are input to further recognizer 224, which performs, using machine learning, a process 114 similar to the process performed by recognizers 212a, 212b, . . . 212n at 106a, 106b, . . . 106n, respectively. Input speech signal may be stored in cache 220 during the processing by recognizers 212a, 212b, . . . 212n and then input to further recognizer 224 when it has received language indications 110a, 110b, . . . 110n from recognizers 212a, 212b, . . . 212n. Based on language indications 110a, 110b, . . . 110n, further recognizer 224 access language models for languages Language a, Language b, . . . Language n identified by the language indications to compare input speech signal 216. Further recognizer 224 generates a score based on how similar the input speech signal 216 is to each of languages Language a, Language b, . . . Language n and outputs 120 an identification 230 of the detected language having the highest score, which is deemed to be the language of the input speech signal. Detected language identification 230 is used to instruct a downstream device 240 of the identified language so that the downstream device 240 can perform operations such as translations, transcriptions, speech-to-text, text-to-speech, image text extraction and other ASR functions.

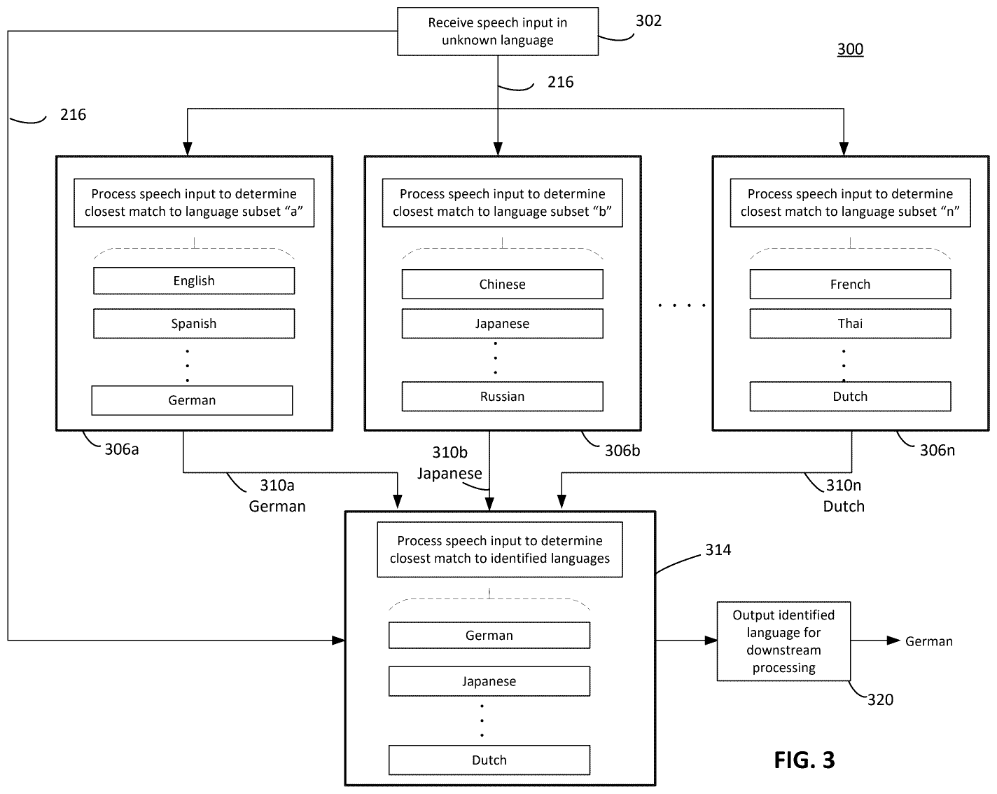

A specific example of the operation of an implementation of system 200 of FIG. 2 is shown is flowchart 300 in FIG. 3. In an example scenario, a foreign passenger approaches a customs screening at an airport or other port of entry. When the passenger begins speaking to the customs agent in a language unknown to or unidentifiable by the agent, the passenger″s speech 216 is input to the system 200 at 302. The input speech signal is then input to each of recognizers 212a, 212b, . . . 212n for processing at 306a, 306b, . . . 306n, respectively. As shown in FIG. 3, recognizer 212a processes the input speech signal with language models for English, Spanish, . . . German 306a. Recognizer 212a simultaneously determines which of its associated languages (English, Spanish, . . . German) the input speech signal is closest to by determining a score for each language based on a comparison of the input speech signal 216 with each language. In this example, recognizer 212a determines that the input speech signal is closest to German, based on German having the highest score. A n indication 310a is output that specifies German as the most likely language of the input speech signal from the subset of languages processed by recognizer 212a.

Recognizer 212b processes the input speech signal with language models for Chinese, Japanese, . . . Russian 306.b. Recognizer 212b simultaneously determines which of its associated languages (Chinese, Japanese, . . . Russian) the input speech signal is closest to by determining a score for each language based on a comparison of the input speech signal 216 with each language. In this example, recognizer 212b determines that the input speech signal is closest to Japanese, based on Japanese having the highest score. An indication 310b is output that specifies Japanese as the most likely language of the input speech signal from the subset of languages processed by recognizer 212b.

Recognizer 212n processes the input speech signal with language models for French, Thai, . . . Dutch, 306a. Recognizer 212n simultaneously determines which of its associated languages (French, Thai, . . . Dutch) the input speech signal is closest to by determining a score for each language based on a comparison of the input speech signal 216 with each language. In this example, recognizer 212n determines that the input speech signal is closest to Dutch, based on Dutch having the highest score. An indication 310n is output that specifies Dutch as the most likely language of the input speech signal from the subset of languages processed by recognizer 212n.

Further recognizer 224 receives indications 310a, 310b, . . . 310n specifying German, Japanese, . . . Dutch as the most likely language of the input speech signal. Further recognizer 224 processes the input speech signal 216 with language models for German, Japanese, . . . Dutch 314. Recognizer 224 simultaneously determines which of the indicated languages (German, Japanese, . . . Dutch) the input speech signal is closest to by determining a score for each language based on a comparison of the input speech signal 216 with each language. In this example, recognizer 224 determines that the input speech signal is closest to German, based on German having the highest score. A indication 230 is output 320 to downstream device 240 that specifies German as the most likely language of the input speech signal from the subset of languages processed by further recognizer 224. Downstream device is then able to process further speech from the passenger by using a German language model for translations, transcriptions, etc. to facilitate communication between the passenger and the customs agent.

Accordingly, implementations of the disclosure process an input speech signal of an unknown language in a multi-threaded model in which a plurality of parallel recognizers, each configured to simultaneously compare the input speech signal to a plurality of languages, identify the language that is the closest to the language of the input speech signal. The input speech signal is then processed in a further recognizer that identifies which of the languages identified by the parallel recognizers is the actual language of the input speech signal. Additionally, by implementing multiple recognizers in parallel that process for different languages, the system introduces minimal overhead comparing to running a single language identification recognizer. The multi-threaded model ensures that the preliminary recognizers run efficiently to cover all the supported languages, and all the recognizers use the same audio data for better performance and consistency. Further, the system is expandable by adding additional recognizers to accommodate support for additional languages. In another implementation, more than two recognition stages may be utilized to process the input speech signal, in which intermediate stages further filter identified languages from a previous stage.

### System Overview:

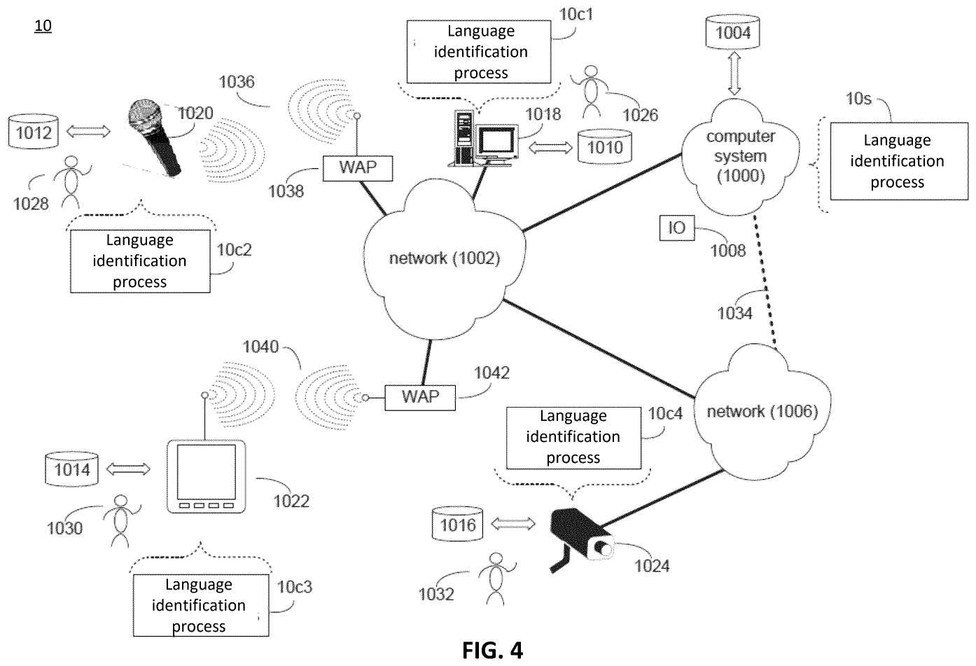

Referring to FIG. 4, there is shown a language identification process 10. Language identification process 10 may be implemented as a server-side process, a client-side process, or a hybrid server-side/client-side process. For example, language identification process 10 may be implemented as a purely server-side process via computational cost reduction process 10s. Alternatively, language identification process 10 may be implemented as a purely client-side process via one or more of language identification process 10c1, language identification process 10c2, language identification process 10c3, and language identification process 10c4. Alternatively still, language identification process 10 may be implemented as a hybrid server-side/client-side process via language identification process 10s in combination with one or more of language identification process 10c1, language identification process 10c2, language identification process 10c3, and language identification process 10c4.

Accordingly, language identification process 10 as used in this disclosure may include any combination of language identification process 10, language identification process 10c1, language identification process 10c2, language identification process 10c3, and language identification process 10c4.

Language identification process 10s may be a server application and may reside on and may be executed by a computer system 1000, which may be connected to network 1002 (e.g., the Internet or a local area network). Computer system 1000 may include various components, examples of which may include but are not limited to: a personal computer, a server computer, a series of server computers, a mini computer, a mainframe computer, one or more Network Attached Storage (NAS) systems, one or more Storage Area Network (SAN) systems, one or more Platform as a Service (PaaS) systems, one or more Infrastructure as a Service (IaaS) systems, one or more Software as a Service (SaaS) systems, a cloud-based computational system, and a cloud-based storage platform.

A SAN includes one or more of a personal computer, a server computer, a series of server computers, a minicomputer, a mainframe computer, a RAID device and a NAS system. The various components of computer system 1000 may execute one or more operating systems.

The instruction sets and subroutines of computational cost reduction process 10s, which may be stored on storage device 1004 coupled to computer system 1000, may be executed by one or more processors (not shown) and one or more memory architectures (not shown) included within computer system 1000. Examples of storage device 1004 may include but are not limited to: a hard disk drive; a RAID device; a random-access memory (RAM); a read-only memory (ROM); and all forms of flash memory storage devices.

Network 1002 may be connected to one or more secondary networks (e.g., network 1004), examples of which may include but are not limited to: a local area network; a wide area network; or an intranet, for example.

Various IO requests (e.g., IO request 1008) may be sent from language identification process 10s, language identification process 10c1, language identification process 10c2, language identification process 10c3 and/or language identification process 10c4 to computer system 1000. Examples of IO request 1008 may include but are not limited to data write requests (i.e., a request that content be written to computer system 1000) and data read requests (i.e., a request that content be read from computer system 1000).

The instruction sets and subroutines of language identification process 10c1, language identification process 10c2, language identification process 10c3 and/or computational cost reduction process 10c4, which may be stored on storage devices 1010, 1012, 1014, 1016 (respectively) coupled to client electronic devices 1018, 1020, 1022, 1024 (respectively), may be executed by one or more processors (not shown) and one or more memory architectures (not shown) incorporated into client electronic devices 1018, 1020, 1022, 1024 (respectively). Storage devices 1010, 1012, 1014, 1016 may include but are not limited to: hard disk drives; optical drives; RAID devices; random access memories (RAM); read-only memories (ROM), and all forms of flash memory storage devices. Examples of client electronic devices 1018, 1020, 1022, 1024 may include, but are not limited to, personal computing device 1018 (e.g., a smart phone, a personal digital assistant, a laptop computer, a notebook computer, and a desktop computer), audio input device 1020 (e.g., a handheld microphone, a lapel microphone, an embedded microphone (such as those embedded within eyeglasses, smart phones, tablet computers and/or watches) and an audio recording device), display device 1022 (e.g., a tablet computer, a computer monitor, and a smart television), a hybrid device (e.g., a single device that includes the functionality of one or more of the above-references devices; not shown), an audio rendering device (e.g., a speaker system, a headphone system, or an earbud system; not shown), and a dedicated network device (not shown).

Users 1026, 1028, 1030, 1032 may access computer system 1000 directly through network 1002 or through secondary network 1006. Further, computer system 1000 may be connected to network 1002 through secondary network 1006, as illustrated with link line 1034.

The various client electronic devices (e.g., client electronic devices 1018, 1020, 1022, 1024) may be directly or indirectly coupled to network 1002 (or network 1006). For example, personal computing device 1018 is shown directly coupled to network 1002 via a hardwired network connection. Further, machine vision input device 1024 is shown directly coupled to network 1006 via a hardwired network connection. Audio input device 1022 is shown wirelessly coupled to network 1002 via wireless communication channel 1036 established between audio input device 1020 and wireless access point (i.e., WAP) 1038, which is shown directly coupled to network 1002. WAP 1038 may be, for example, an IEEE 802.11a, 802.11b, 802.11g, 802.11n, Wi-Fi, and/or any device that is capable of establishing wireless communication channel 1036 between audio input device 1020 and WAP 1038. Display device 1022 is shown wirelessly coupled to network 1002 via wireless communication channel 1040 established between display device 1022 and WAP 1042, which is shown directly coupled to network 1002.

The various client electronic devices (e.g., client electronic devices 1018, 1020, 1022, 1024) may each execute an operating system, wherein the combination of the various client electronic devices (e.g., client electronic devices 1018, 1020, 1022, 1024) and computer system 1000 may form modular system 1044.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a ““circuit,”” ““module”” or ““system.”” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the ““C”” programming language or similar programming languages. The program code may execute entirely on the user″s computer, partly on the user″s computer, as a stand-alone software package, partly on the user″s computer and partly on a remote computer or entirely on the remote computer or server. In the latter scenario, the remote computer may be connected to the user″s computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms ““a””, ““an”” and ““the”” are intended to include the plural forms as well, unless the context clearly indicates otherwise. It will be further understood that the terms ““comprises”” and/or ““comprising,”” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
receiving an input speech signal in a particular language of a plurality of languages;
processing the input speech signal by a plurality of speech recognition processing paths, each speech recognition processing path being configured to recognize an associated subset of the plurality languages;
each of the plurality of speech recognition processing paths processing the input speech signal using machine learning to identify a language in the associated subset of languages which is a closest match to the particular language of the input speech signal, the processing of the input speech signal by the plurality of speech recognition processing paths resulting in a plurality of identified languages; and
receiving the input speech signal and an indication of each of the plurality of identified languages in a further speech recognition processing path and processing, using machine learning, the input speech signal to recognize one of the plurality of identified languages as a closest match to the particular language of the input speech signal.

2. The computer-implemented method of claim 1 wherein each speech recognition processing path associated subset includes languages not in any other speech recognition processing path associated subset.

3. The computer-implemented method of claim 2 further including caching the input speech signal for input to the further speech recognition processing path.

4. The computer-implemented method of claim 1 wherein each speech recognition processing path associated subset includes languages common with languages in another speech recognition processing path associated subset.

5. The computer-implemented method of claim 1 wherein the input speech signal is streamed simultaneously to each of the plurality of speech recognition processing paths.

6. The computer-implemented method of claim 1 wherein the plurality of speech recognition processing paths operate in parallel with each other.

7. The computer-implemented method of claim 1 wherein the plurality of speech recognition processing paths comprise a deep neural network utilizing an x-vector framework.

8. A computing system comprising:
a memory; and
a processor to:
receive an input speech signal in a particular language of a plurality of languages;
process the input speech signal by a plurality of language recognizers, each language recognizer being configured to recognize an associated subset of the plurality languages;
process, by each of the plurality of language recognizers, the input speech signal using machine learning to identify a language in the associated subset of languages which is a closest match to the particular language of the input speech signal, the processing of the input speech signal by the plurality of language recognizers resulting in a plurality of identified languages; and
receive the input speech signal and an indication of each of the plurality of identified languages in a further language recognizer and processing, using machine learning, the input speech signal to recognize one of the plurality of identified languages as a closest match to the particular language of the input speech signal.

9. The computing system of claim 8 wherein each language recognizer associated subset includes languages not in any other language recognizer associated subset.

10. The computing system of claim 9 further including caching the input speech signal for input to the further language recognizer.

11. The computing system of claim 8 wherein each language recognizer associated subset includes languages common with languages in another language recognizer subset.

12. The computing system of claim 8 wherein the input speech signal is streamed simultaneously to each of the plurality of language recognizers.

13. The computing system of claim 8 wherein the plurality of language recognizers operate in parallel with each other.

14. The computing system of claim 8 wherein the plurality of language recognizers comprise a deep neural network utilizing an x-vector framework.

15. A computer program product residing on a non-transitory computer readable medium having a plurality of instructions stored thereon which, when executed by a processor, cause the processor to perform operations comprising:
receiving an input speech signal in a particular language of a plurality of languages;
processing the input speech signal by a plurality of speech recognition processing paths, each speech recognition processing path being provided with a set of language models to enable the speech recognition processing path to recognize a plurality of languages;
each speech recognition processing path processing the input speech signal using machine learning to indicate an identified language which is a closest match to the particular language of the input speech signal, the processing of the input speech signal by the plurality of language recognizers resulting in a plurality of identified languages; and
receiving the input speech signal and an indication of each of the plurality of identified languages in a further speech recognition processing path and processing, using machine learning, the input speech signal to recognize one of the plurality of identified languages as a closest match to the particular language of the input speech signal.

16. The computing system of claim 15 wherein each set of language models of each speech recognition processing path includes language models not in common with language models in the set of language models of another speech recognition processing path.

17. The computing system of claim 16 further including caching the input speech signal for input to the further speech recognition processing path.

18. The computing system of claim 15 wherein each set of language models of each speech recognition processing path includes language models common with language models in the set of language models of another speech recognition processing path.

19. The computing system of claim 15 wherein the input speech signal is streamed simultaneously to each of the plurality of speech recognition processing paths.

20. The computing system of claim 15 wherein the plurality of speech recognition processing paths operate in parallel with each other.
